(19) United States
(12) Patent Application Publication
(10) Pub. No.: US 2004/0129676 A1
(43) Pub. Date: Jul. 8, 2004

(54) Apparatus for transfer of an array of liquids and methods for manufacturing same

(76) Inventor: Roy H. Tan, Union City, CA (US)

Correspondence Address: Alan L. Cassel, Harness, Dickey & Pierce, Suite 400, 7700 Bonhomme, St. Louis, MO, 63105, US

(21) Appl. No.: 10/337,834

(22) Filed: Jan. 7, 2003

(51) Int. Cl. C23F 1/00; B44C 1/22; C23F 3/00

(52) U.S. Cl. 216/80

(57) ABSTRACT

A method for producing an apparatus for transferring small amounts of liquids includes bonding a plurality of parallel fibers having plural coaxial layers into a bundle, slicing the bundle of parallel fibers in planes perpendicular to the direction of the fibers to form two opposite, planar surfaces, and selectively etching the fiber layers to create etched wells in the fibers at one of the planar surfaces. The etched wells are in fluid communication with corresponding capillary nozzles of the fibers that extend to an opposite one of the planar surfaces. Various apparatus configurations of the present invention include liquid transfer devices manufactured utilizing one or more of the various method configurations of the present invention. By way of example only, a bundle of three-layer optical fibers or a bundle of hollow two-layer optical fibers may be utilized to produce a liquid transfer device.

### FIELD

The present invention relates to an apparatus for the transfer of small amounts of liquids and methods for making such apparatus.

### BACKGROUND

Simultaneous handling of small quantities of many different liquids is sometimes required for chemical and biological research. For example, multiplexed liquid transfer is required for microarray applications, including oligo and cDNA microarrays, protein arrays, and cell based arrays. In addition, multiplexed liquid transfer is also useful for multiplexed nano-ESI (nano-electro-spray ionization) interfaces for high throughput protein analyses, such as proteomic analysis. For example, liquid samples can be introduced into a mass spectrometer with enhanced sensitivity, improved stability and less sample consumption than other approaches. Known DNA microarrays can be prepared utilizing either patterned, light-directed combinatorial chemical synthesis, ink jet techniques in which oligonucleotides are synthesized via solution-based reactions on a substrate, or self-assembled bead arrays that are assembled on an optical fiber substrate.

### SUMMARY

In various configurations of the present invention, there is provided a liquid transfer apparatus that are easily manufactured, and that can be mass produced at low cost with high reproducibility, reliability, and density. Multiplexed nozzles provided in various configurations of the present invention can be utilized to print small quantities, i.e., a small number of picoliters, or solution onto a microslide for high density DNA microarrays. Also, various configurations of the present invention are useful as a high-throughput mass spectrometer interface for proteomic applications. In addition, various configurations of the present invention provide a method of manufacturing a liquid transfer apparatus that is easily reconfigured, that provides high nozzle uniformity, and simple process control.

There is therefore provided, in various configurations of the present invention, an apparatus for the transfer of an array of liquids. The apparatus includes a bonded array of parallel capillary tubes. The array has a planar well side and an opposite, planar nozzle side. A plurality of the tubes include a microwell at the planar well side and a capillary nozzle in fluid communication with the microwell and extending to the planar nozzle side.

In various configurations of the present invention, there are provided methods for making a liquid transfer device. One such method includes bonding a plurality of parallel fibers having plural coaxial layers into a bundle, slicing the bundle of parallel fibers in planes perpendicular to the direction of the fibers to form two opposite, planar surfaces, and selectively etching the fiber layers to create etched wells in the fibers at one of the planar surfaces. The etched wells are in fluid communication with corresponding capillary nozzles of the fibers that extend to an opposite one of the planar surfaces. Various apparatus configurations of the present invention include liquid transfer devices manufactured utilizing one or more of the various method configurations of the present invention. By way of example only, a bundle of three-layer optical fibers or a bundle of hollow two-layer optical fibers may be utilized to produce a liquid transfer device.

Further areas of applicability of the present invention will become apparent from the detailed description provided hereinafter. It should be understood that the detailed description and specific examples, while including the preferred and other useful embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a drawing of a cross-section through an optical fiber having three coaxial layers.

FIG. 2 is a drawing of a glued bundle of fibers of the type shown in FIG. 1.

FIG. 3 is a cross-sectional view of the glued bundle of fibers at a surface defined by line III-III in FIG. 2.

FIG. 4 is a drawing of another arrangement of glued fibers of the type shown in FIG. 1.

FIG. 5 is a drawing of glued bundle of fibers shown in FIG. 2 sliced into a plurality of slices.

FIG. 6 is a drawing of a surface of a slice show in FIG. 5, showing the application of a resist material to create nozzle tips around capillary openings in the fibers.

FIG. 7 is a drawing of a section of a slice defined by line VII-VII in FIG. 6.

FIG. 8 is a drawing of the front surface of the section shown in FIG. 7, without shading or stippling to illustrate the layers of the fibers.

FIG. 9 is a drawing of a planar, well side of one example of an apparatus of the present invention.

FIG. 10 is a drawing of an opposite, planar nozzle side of the apparatus shown in FIG. 9.

FIG. 11 is a cross-sectional view of a single hollow three layer fiber after having been etched as in various configurations of the present invention.

### DETAILED DESCRIPTION

The following description of the preferred embodiment and other useful embodiments of the present invention is merely exemplary in nature and is in no way intended to limit the invention, its application, or uses.

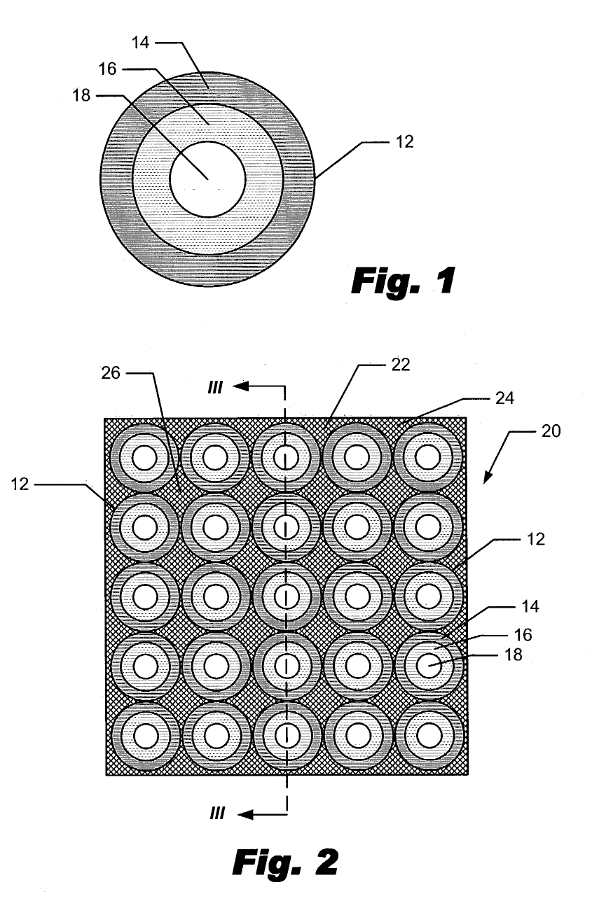

In various configurations and referring to FIGS. 1, 2 and 3, a method is provided for making an apparatus for transferring an array of liquids. The apparatus is particularly suited for the simultaneous transfer of a large number of different liquids in small quantities. To make the apparatus, a plurality of parallel fibers 12 having plural coaxial layers such as 14, 16, and 18 are bonded into a bundle 20 having parallel fibers aligned parallel to an axis or direction D. (The term “coaxial,” as used herein, permits but does not require the layers to have the same central axis. However, each layer fully surrounds the next inner layer. Around layers 14, 16, and 18 having round cross-sections are shown in FIGS. 1, 2 and 3, the cross-sections are not limited to the shape shown, but may be square, hexagonal, octagonal, or other shapes.) For example, fibers 12 are optical fibers having three different doping layers 14, 16, and 18 with different indices of refraction. The different indices of refraction are produced, for example, by different doping of the three layers, which makes layers 14, 16, and 18 susceptible to selective etching. In another example, fibers 12 are hollow fibers or tubes in which a cylindrical void is present instead of a separate layer 18, and layers 14 and 16 are made of distinct materials, such as a plastic polymer and glass, respectively. (For ease of manufacture, the cylindrical void may be temporarily filled with a material such as a low melting temperature wax.)

For example, in some, but not all configurations, layer 18 comprises a boron-doped n+ silicon with at least 10²⁰ cm⁻³ dopant in its crystal structure, layer 16 comprises an undoped silicon layer, and layer 14 comprises a silica (SiO₂), polysilicon or glass material. A mixture of potassium hydroxide (KOH), water, and isopropyl alcohol can be used to etch out undoped silicon (Si) and silica (SiO₂) under 85° C., with the boron-doped silicon (Si) serving as a stop layer, because of the low etching selectivity of KOH to Si and SiO₂. Then, a buffered acid solution such as 8% (v/v) hydrogen fluoride (HF), 75% (v/v) nitric acid (HNO₃) and 17% (v/v) acetic acid (CH₃COOH) can be used to etch n-type silicon and undoped silicon, but not silica. In some, but not all of these configurations, high melting point wax is used to protect center layer or hollow core 18, and/or a crystal plane of the material is chosen to facilitate selective etching. Some, but not all, configurations may utilize one or more electrochemical etch-stop techniques.

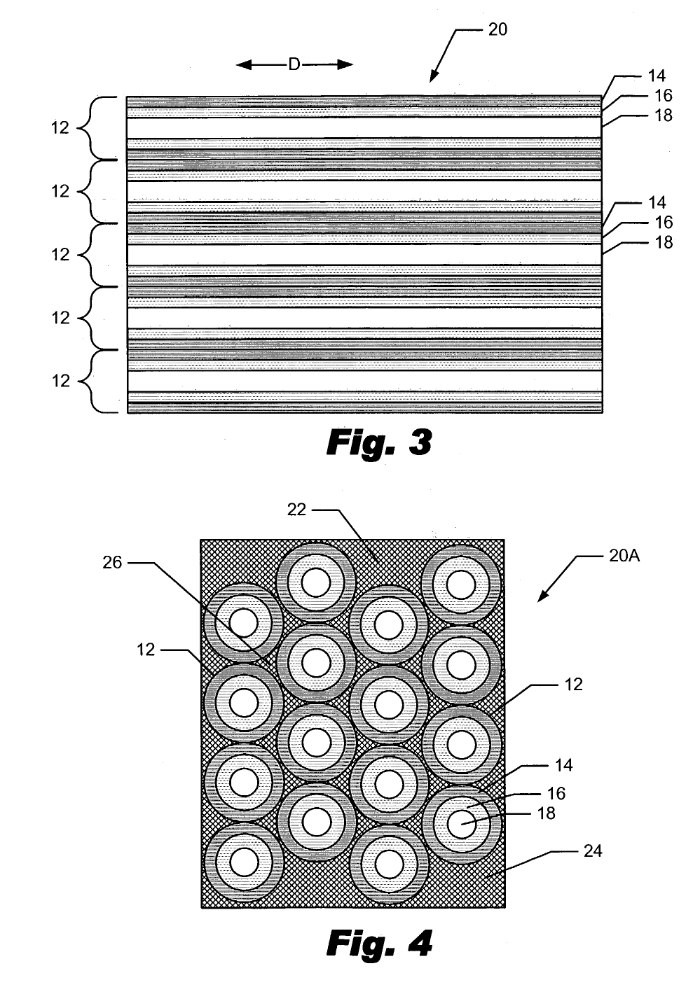

For purposes of this description and the claims appended below, a fiber 12 is considered to have plural coaxial layers even though boundaries between the different layers 14, 16, and/or 18 may not be as sharply defined as implied by the appended Figures. Bundles 20 may contain more fibers 12 than bundles 20 illustrated in FIGS. 2 and 3. For example, fibers 12 are, in some configurations, arranged in an array having a cross section of 24 by 64 fibers, or a total of 1,536 fibers. In some configurations, fibers 12 are arranged in an array having a cross section of 24 by 32 fibers, or a total of 768 fibers. However, the number of fibers 12 need not be equal to either 1,536 or 768, but rather is a design choice that can be made based upon the use to which the resulting apparatus is to be put. Thus, some configurations may have less than 768 fibers, between 768 and 1,536 fibers, or more than 1,536 fibers. Also, bundles are not required to be rectangular in all configurations. An example of a bundle 20A in which fibers 12 are arranged in a non-rectangular pattern is illustrated in FIG. 4.

In various configurations, fibers 12 of bundle 20 (or 20A) are bonded together utilizing an etch-resistant material 22 (e.g., a polymer or glue) that fills areas 24 between fibers 12 at the boundaries of bundle 20 and interstitial voids 26 between fibers 12. Before material 22 hardens, bundle 20 is pulled into a desired dimension that can be used for dispensing. For example, a bundle 20 of fibers 12 having a cross section of 24 by 64 fibers may be pulled into a desired rectangular shape having dimensions of about 3 millimeters by about 7 millimeters, and a bundle 20 of fibers 12 having a rectangular of 24 by 32 fibers may be pulled into a desired rectangular shape having dimensions of about 3 millimeters by about 4 millimeters for dispensing. Thus, with appropriate selection of fiber 12 diameters, between 768 and 1536 fibers 12 (which either are or become capillary tubes in the completed apparatus) are contained within an area of no more than about 21 square centimeters in some configurations. However, the invention is not limited to these fiber dimensions, areas, or numbers of fibers.

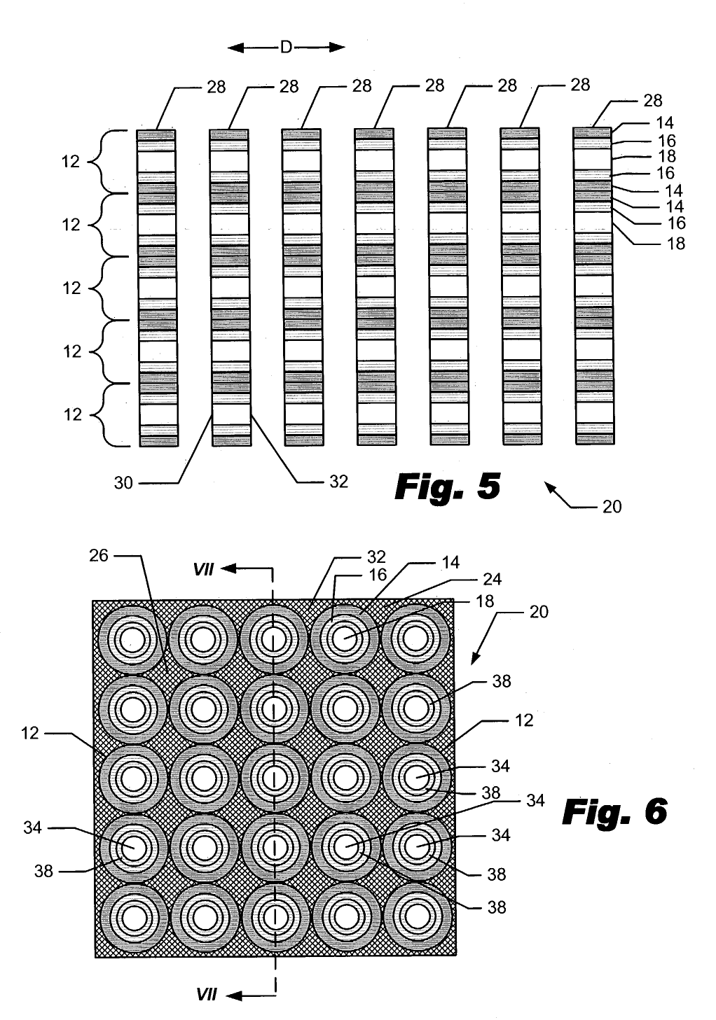

The invention does not require, however, that the bundle have a rectangular cross section. Referring to FIG. 5, dispensed bundle 20 is sliced perpendicular to the direction D of fibers 12 to form two opposite planar surfaces 30 and 32 on a slice 28. In some configurations, bundle 20 is sliced a plurality of times to produce a plurality of slices 28 and corresponding planar surfaces 30 and 32. In the case of a rectangular bundle 20, slices 28 are rectangular slices in which surfaces 30 and 32 have dimensions equal to the cross section of bundle 20 and a thickness determined by the spacing of the slices.

The thickness of each slice in direction D is selected in accordance with the use to which the resulting apparatus is to be put. For example, for at least one type of use, a slice thickness of about 2 millimeters is selected. In various configurations, surfaces 30 and 32 of slices 28 are polished to an optical flatness to very precisely control the thickness of the slices.

In various configurations and referring to FIGS. 5 and 6, fibers 12 in bundle 20 have a plurality of coaxial layers 14, 16, and 18. For example, fibers 12 are fiber optic fibers having three layers 14, 16, and 18 with different refractive indices and thus, different doping levels. As a result, layers 14, 16, and/or 18 can be, and are, selectively etched by the selection of appropriate etchants. More particularly, in various configurations, a center core corresponding to layer 18 is etched through the entire bundle utilizing an etchant that preferentially attacks layer 18. For example, layer 18 is doped in a manner that makes it susceptible to etching using a relatively mild etchant, such as an amine solution. Slice 28 is suspended or dipped or otherwise treated in or with this solution to etch central holes in fibers 12 corresponding to layers 18 to make capillaries 34 that extend from surface 30 to surface 32. In some configurations, capillaries 34 are between about 1 micron and about 10 microns in diameter. The etchant is selected so that neither layer 14, layer 16, nor material 22 is significantly affected during the etching of layer 18. After etching capillaries 34 through from surface 30 to surface 32, slice 28 is removed from the mild etchant and its surfaces cleaned or washed. Next, one surface 32 of slice 28 is protected while a more active etchant is applied to surface 30, for example, by spraying. This more active etchant, for example, a potassium hydroxide solution, is selected to preferentially etch layer 16 of fibers 12, but not to significantly attack layer 14 or material 22. The more active etchant is allowed to etch only partway through slice 28 from surface 30 towards surface 32, however, thus creating wells 36 (which are also referred to herein as microwells 36) in surface 30. For example, microwells 36 are etched deeply enough to store, in their volume, about 5 microliters of liquid. These wells 36 are each in fluid communication with a corresponding capillary nozzle 34 in the same fiber 12. Each capillary nozzle 34 for each etched fiber 12 extends to an planar surface 32 opposite surface 30 in which wells 36 are etched. The active etchant is then removed and slice 28 is again cleaned or washed.

In at least some configurations, it is possible to apply the more active etchant to slice 28 while surface 32 is protected, before application of the less active etchant. The initial application of the more active etchant is timed to result in the etching of wells 36 and only a portion of capillary nozzles 34. The more active agent is then removed and washed away and the less active agent is applied to complete the etching through of capillary nozzles 34.

In some configurations, fibers 12 are hollow fibers, in which a capillary void 34 of cylindrical (or other) shape is already present instead of layer 18. In these configurations, it is not necessary to apply a mild etchant to etch capillaries 34, as fibers 12 already contain these capillaries. An appropriate etchant is used to etch layer 16. In some configurations, capillary void 34 is temporarily filled with another material such a low-melting temperature wax, so that surface 32 can be patterned. After patterning, the wax is removed, for example, by heating.

Regardless of whether fibers 12 are hollow prior to etching or become hollow after etching, the etching process described above results in slice 28 being comprised of a bonded array of parallel fibers 12, which by any of the above-described processes become capillary tubes. The array has a planar well side 30 and an opposite, planar nozzle side 32, and a plurality of capillary tubes 28 include a microwell 36 at planar well side 30 and a capillary nozzle 34 in fluid communication with microwell 36. Capillary nozzle 34 extends to planar nozzle side 34. For example, capillary nozzles 34 are about 300 microns in length, microwells 36 hold about 5 microliters of liquid, and each capillary nozzle opening has a diameter between about 1 and about 10 microns. In some configurations, capillary tubes 12 comprise optical fiber.

Although liquid etching agents are described herein, the invention is not limited to the use of liquid etchants and other suitable types of etching agents and/or methods may be utilized in various configurations of the present invention.

In various configurations and referring to FIG. 6, an additional etching step is performed. A resist material such as photoresist is deposited or otherwise patterned on surface 32 around each capillary opening over a portion 38 of surface 32 around each capillary 34 opening in surface 32. In some configurations, the photoresist material applied at each opening 34 has a diameter less than that which would be required to completely cover layer 16 of the fiber 12 through which opening 34 passes. Then, surface 32 is etched with a strong etchant to remove a small volume of at least that portion of layer 16 at surface 32 that surrounds portion 38, leaving an annular tip 40 around capillary 34 nozzle openings or holes, which pass through tip 40. Annular tips 40 are flush with a plane of planar nozzle side 32 of slice 28; i.e., each tip extends to a surface of what remains of planar surface 32. In some configurations, the etchant is selected to be sufficiently strong to etch the entire surface 32 a small uniform amount, except those portions protected by the photoresist material. In these configurations, annular nozzle tips 40 are all that remain of the original surface 32, and annular nozzle tips 40 rise above the etched surface by a small, uniform amount.

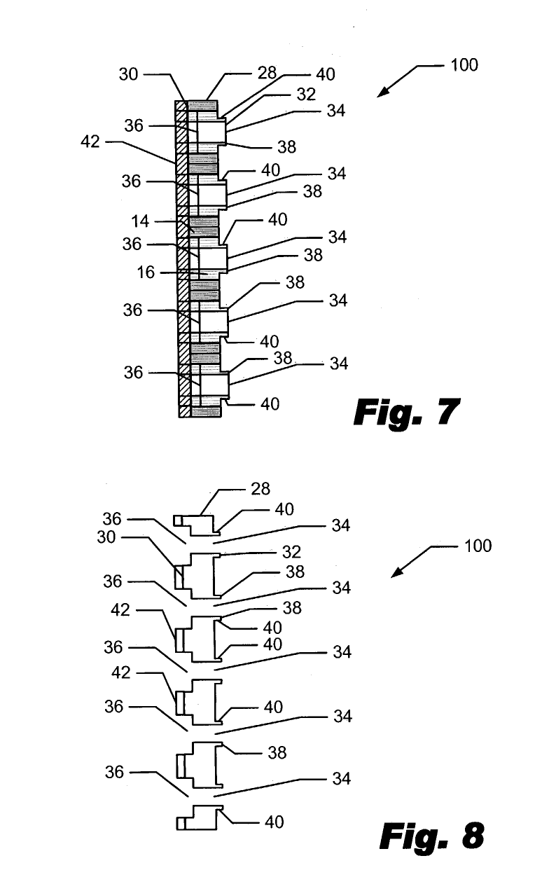

In various configurations and referring to FIGS. 7 and 8, a hydrophobic insulation material 42 such as silica, Teflon, or fluorocarbon material is deposited on surface 30 after etching to produce a hydrophobic insulation between wells.

In some configurations, metallic materials are patterned onto surface 32 to allow electricity to be selectively applied or connected to one or more individual nozzles, thus making sequential or random selection possible for applications such as electrospraying. In some configurations, a uniform metallic layer is used to ground all of the nozzles at the same time. For example, wires can be connected onto a device from four sides so that each nozzle can be addressed independently.

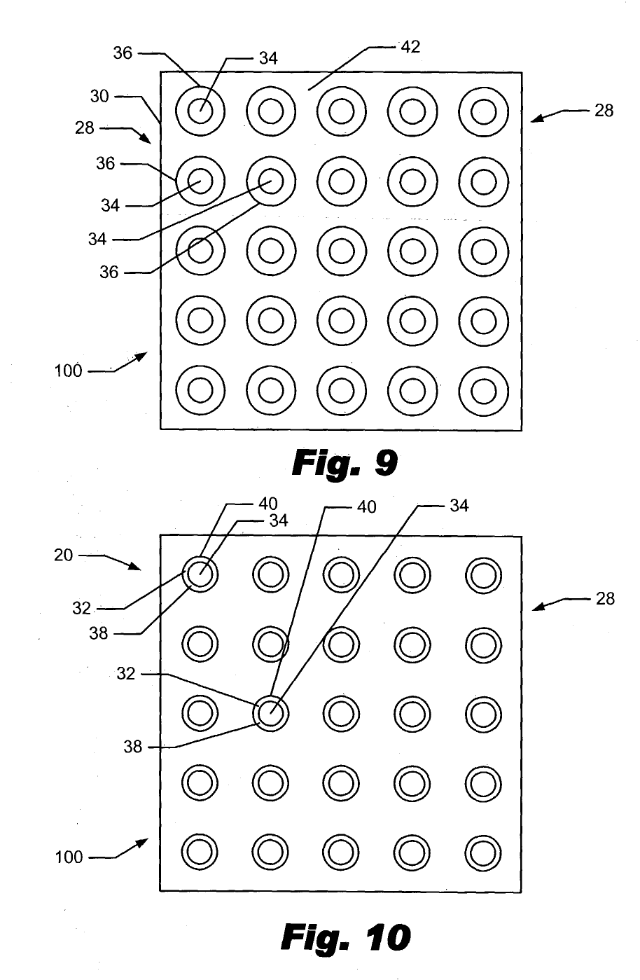

An apparatus 100 suitable for transfer of an array of liquids is shown in various views in FIGS. 7, 8, 9, and 10. FIG. 7 shows a cross section of the surface defined by line VII-VII in FIG. 6. FIG. 8 is a representation of the surface of the cross section shown in FIG. 7, i.e., the intersection of the plane represented by line VII-VII in FIG. 6. FIG. 9 is a representation of a planar, well side corresponding to surface 30, and FIG. 10 is a representation of an opposite, planar, nozzle side corresponding to surface 32.

In most conventional liquid transfer systems, whether a robotic liquid handling apparatus or a simple pipette, liquid volumes between 1 and 5 microliters can be precisely and reliably handled. However, liquid droplets dispensed by configurations of the present invention are useful for biological applications such as microarray, microfluidics, and protiomics in the picoliter and sub-nanoliter liquid volume ranges. For example, a liquid deposited on an oligo microarray surface forming a 100 micron spot has a volume of about 500 picoliters. Methods and apparatus of the present invention are thus useful as liquid handling tools that bridge the gap between the macro-world of machines and the micro-world of biological events.

Forces or energy applied to microwells 36 to move liquid inside center capillaries 34 to the nozzle tip are not limited to pressure forces. For example, liquid flow can be driven by electricity, positive pressure, surface tension (capillary action), or by a combination thereof. In various applications, arrays of different liquids can be transferred by combinations of forces.

In some configurations, the arrangement of individual fibers on a planar surface projects into a 96-well plate format on a smaller scale. The pitch of a bundle of fibers have a dividend of 9 mm or the pitch can be divided by 9 mm. Although the invention is not limited to configurations having this footprint, integral projections of the 96-well plat format provide a useful and simple interface for many applications. For example, fibers are arranged having center-to-center distances of 2.25 mm, 1.25 mm, 1 mm, 0.5 mm, 0.25 mm, or 0.125 mm.

Configurations of the present invention are not limited to optical fibers having no more than three layers. Optical fibers having additional layers may also be utilized. For example, in configurations in which four layer optical fiber is utilized, the entire photoresist coating and patterning process can be eliminated. By selecting an appropriate etching rate, nozzles can be formed automatically.

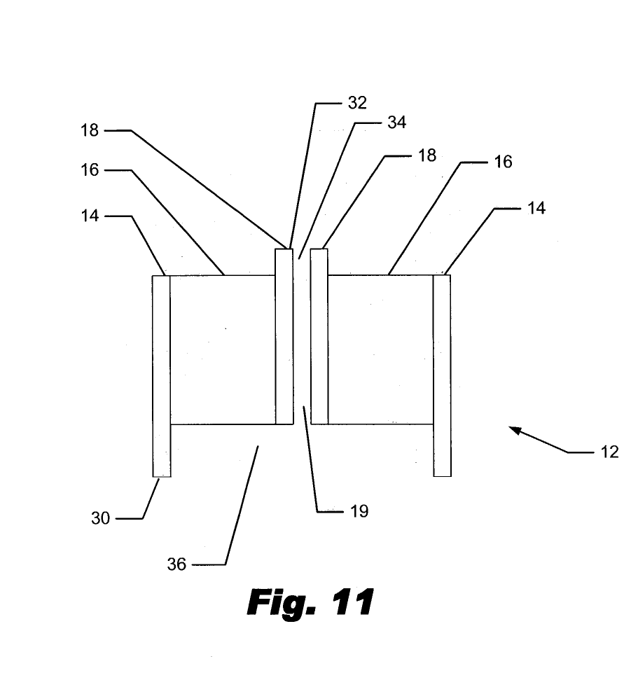

Some configurations utilize hollow three layer optical fiber, i.e., fiber in which layer 18 of FIG. 1 is present, but has a center hole 19. In some configurations and referring to the cross-sectional view of FIG. 11, photoresist and photolithography steps are eliminated, and etchings are reduced to two dipping or spraying steps. A three layer hollow fiber 12A having an outer layer 14, a middle layer 16, and an inner layer 18A is utilized in these configurations. Inner layer 18A has a central hollow portion 19. An etchant is used to etch layers 16 and 18A on well side 30, and another etchant is used to etch layers 14 and 16 on nozzle side 32.

Some configurations utilize four layer optical fiber. In these configurations, center hole 19 shown in FIG. 11 is prepared by etching an innermost layer of the four layer optical fiber all the way through from surface 30 to surface 32. (The innermost layer of four layer optical fiber is not shown in FIG. 11, but is etched away to create center hole 19.) The second innermost layer in a four-layer optical fiber or, correspondingly, the inner layer 18A of a hollow three-layer fiber 12A forms the nozzle itself. Although, for the sake of simplicity of illustration, FIG. 11 illustrates only one fiber 12A, many configurations of the present invention utilizing hollow three layer fiber or four layer fiber will include a plurality of fibers 12A, which may be arranged in configurations similar to those discussed above.

In some configurations, an etching stop layer is provided with 10²⁰ cm⁻² boron-doped (n-type) silicon (Si) and 10²¹ cm⁻² gallium-doped (p-type) silica. In a four-layer configuration, the layers may, but do not have to comprise, un-doped silicon, doped silicon, un-doped silicon, and glass, in various layered combinations that can be selected and structured. Because there is no optical requirement imposed by configurations of the present invention, the layers can be provided in any order (from outer layer to core) suitable for etching with selected etchants. In a manufacturing line, one or more coaxial layers can be doped while the other(s) is/are oxidized, while the layers are being pulled in the axial direction.

It will thus be appreciated that various configurations of the present invention provide a liquid transfer apparatus that are easily manufactured, and that can be mass produced at low cost with high reproducibility, reliability, and density. Multiplexed nozzles provided in various configurations of the present invention can be utilized to print small quantities, i.e., a small number of picoliters, or solution onto a microslide for high density DNA microarrays. Also, various configurations of the present invention are useful as a high-throughput mass spectrometer interface for proteomic applications. In addition, various configurations of the present invention provide a method of manufacturing a liquid transfer apparatus that is easily reconfigured, that provides high nozzle uniformity, and simple process control. In addition, some configurations of the present invention provide an array of small tips on one side and a microwell array on the other, which is useful for microarray printing technologies, wherein a few picoliters of solutions are printed on a microslide.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for transfer of an array of liquids, said apparatus comprising a bonded array of parallel capillary tubes, the array having a planar well side and an opposite, planar nozzle side, wherein a plurality of said capillary tubes include a microwell at the planar well side and a capillary nozzle in fluid communication with the microwell extending to the planar nozzle side.

2. An apparatus in accordance with claim 1 wherein said capillary tubes comprise optical fiber.

3. An apparatus in accordance with claim 1 wherein said microwells are configured to hold a volume of about 5 microliters of liquid.

4. An apparatus in accordance with claim 1 wherein said capillary nozzles comprise an annular tip with a hole passing therethrough at the planar nozzle side of said apparatus.

5. An apparatus in accordance with claim 4 wherein ends of said cylindrical tips are flush with a plane of the planar nozzle side of said apparatus.

6. An apparatus in accordance with claim 1 wherein said capillary tubes are about 300 microns in length, including a well configured to hold about 5 microliters liters of liquid, and the capillary nozzle has an opening of between about 1 and about 10 microns in diameter.

7. An apparatus in accordance with claim 6 including at least 96 capillary tubes.

8. An apparatus in accordance with claim 7 including between 96 and 1536 capillary tubes within an area of no more than about 21 square millimeters.

9. An apparatus in accordance with claim 1 further comprising a hydrophobic insulation between wells deposited on a surface land area of said planar well side.

10. An apparatus in accordance with claim 9 wherein the hydrophobic insulation comprises at least one member of the group consisting of deposited silica, Teflon, or fluorocarbon material.

11. An apparatus in accordance with claim 1 wherein the planar well side and the planar nozzle side are polished to an optical flatness.

12. A method for making a liquid transfer device, said method comprising:
bonding a plurality of parallel fibers having plural coaxial layers into a bundle;
slicing the bundle of parallel fibers in planes perpendicular to the direction of the fibers to form two opposite, planar surfaces,
selectively etching the fiber layers to create etched wells in the fibers at one of the planar surfaces, wherein the etched wells are in fluid communication with corresponding capillary nozzles of the fibers that extend to an opposite one of the planar surfaces.

13. A method in accordance with claim 12 wherein said bonding a plurality of parallel fibers having plural coaxial layers into a bundle comprises bonding a plurality of parallel optical fibers having coaxial layers into a bundle.

14. A method in accordance with claim 12, wherein the parallel fibers are three-layer fibers, each layer corresponding to one of said coaxial layers; and further wherein
said selectively etching the fiber layers comprises etching center layers of said coaxial layers between one said planar surface and said opposite planar surface to form said capillary nozzles, and etching a well in middle layers of said coaxial layers surrounding said center layers from one said planar surface only a portion of the distance to the opposite planar surface to form said etched wells.

15. A method in accordance with claim 14 wherein said selectively etching the fiber layers further comprises etching said nozzles to a diameter in a range of about 1 micron to about 10 microns.

16. A method in accordance with claim 15 wherein said selectively etching the fiber layers further comprises etching said wells to a volume of about 5 microliters each.

17. A method in accordance with claim 14 further comprising depositing a hydrophobic insulation between wells on land areas of the planar surface having the etched wells.

18. A method in accordance with claim 17 wherein said depositing a hydrophobic insulation comprises depositing at least one member of the group consisting of silica, Teflon, and fluorocarbon material between wells on the land areas of the planar surface having the etched wells.

19. A method in accordance with claim 12 further comprising pulling the bundle of parallel fibers into a desired dimension.

20. A method in accordance with claim 12 further comprising polishing the planar surfaces to an optical flatness.

21. A method in accordance with claim 12 further comprising applying a resist material around the capillary nozzle openings on one of the planar surfaces and etching a portion of the planar surface around the resist materials to thereby form tips around the nozzle openings.

22. A method in accordance with claim 12 wherein said bonding a plurality of parallel fibers having plural coaxial layers into a bundle comprises bonding a plurality of hollow fibers into a bundle.

23. A method in accordance with claim 22 wherein said coaxial layers surround capillary holes through the fibers, and said selectively etching the fiber layers comprises etching a layer surrounding the capillary hole only a portion of the distance to the opposite planar surface to form said etched wells.

24. A method in accordance with claim 23 wherein said capillary holes have a diameter in a range of about 1 micron to about 10 microns, and said selectively etching the fiber layers further comprises etching said wells to a volume of about 5 microliters each.

25. A method in accordance with claim 23 further comprising depositing a hydrophobic insulation between wells on land areas of the planar surface having the etched walls.

26. A method in accordance with claim 25 wherein said depositing a hydrophobic insulation comprises depositing silica between wells on the land areas of the planar surface having the etched wells.

27. A method in accordance with claim 22 further comprising pulling the bundle of parallel fibers into a desired dimension.

28. A method in accordance with claim 22 further comprising polishing the planar surfaces to an optical flatness.

29. An apparatus for transfer of an array of liquids produced by a method in accordance with claim 12.

30. An apparatus for transfer of an array of liquids produced by a method in accordance with claim 13.

31. An apparatus for transfer of an array of liquids produced by a method in accordance with claim 14.

32. An apparatus for transfer of an array of liquids produced by a method in accordance with claim 15.

33. An apparatus for transfer of an array of liquids produced by a method in accordance with claim 21.

34. An apparatus for transfer of an array of liquids produced by a method in accordance with claim 22.

35. An apparatus for transfer of an array of liquids produced by a method in accordance with claim 23.

36. An apparatus for transfer of an array of liquids produced by a method in accordance with claim 24.

37. An apparatus for transfer of an array of liquids produced by a method in accordance with claim 25.

38. A method in accordance with claim 12 wherein said bonding a plurality of parallel fibers comprises bonding a plurality of hollow three-layer fibers, and selectively etching the fiber layers comprises applying different etchants to the opposite planar surfaces.

39. A method in accordance with claim 12 wherein said bonding a plurality of parallel fibers comprises bonding a plurality of hollow three-layer fibers, and selectively etching the fiber layers comprises applying no more than two different etchants, wherein one said etchant is applied to one of the opposite planar surfaces and the other said etchant to the other one of the opposite planar surfaces.

40. A method in accordance with claim 12 wherein the parallel fibers are hollow fibers with capillary voids, and said method further comprises temporarily filling the capillary voids.

41. A method in accordance with claim 40 wherein said capillary voids are temporarily filled with wax.

42. A method in accordance with claim 12 wherein said bonding a plurality of parallel fibers comprises bonding a plurality of four layer fibers.

43. A method in accordance with claim 12 wherein said selectively etching the fiber layers comprises etching out undoped silicon and silica utilizing a mixture of potassium hydroxide, water, and isopropyl alcohol.

44. A method in accordance with claim 43 further comprising an additional etching utilizing a buffered acid solution.

45. A method in accordance with claim 44 wherein the buffered acid solution comprises a mixture of hydrofluoric acid, nitric acid, and acetic acid.
